(19) United States
(12) Patent Application Publication
(10) Pub. No.: US 2016/0236656 A1
(43) Pub. Date: Aug. 18, 2016

(54) ATTACHMENT FOR A WINDSCREEN WIPER, ESPECIALLY AN AUTOMOTIVE WIPER, A WIPER BLADE CONTAINING SUCH AN ATTACHMENT, AND AN AUTOMOTIVE WIPER ASSEMBLY

(71) Applicant: Valeo Autosystemy Sp. z o.o., Skawina (PL)

(72) Inventors: Michal Malec, Skawina (PL); Andrzej Szewezyk, Skawina (PL); Grzegorz Wielgus, Krakow (PL)

(73) Assignee: Valeo Autosystemy Sp. z o.o., Skawina (PL)

(21) Appl. No.: 15/028,089

(22) PCT Filed: Oct. 7, 2014
(86) PCT No.: PCT/IB2014/002297

§ 371 Date: Apr. 8, 2016

(30) Foreign Application Priority Data
Oct. 9, 2013 (PL) P.405579

(51) Int. Cl. B60S 1/38; B60S 1/40

(52) U.S. Cl. CPC B60S 1/3853; B60S 1/4048; B60S 2001/4054

(57) ABSTRACT

The subject of the invention is an attachment (3) of a wiper device, designed for fastening in a wiper arm (5) by a snap-fit connection, designed and configured for its connection to a connector (2) for fastening the wiper blade (1), wherein said snap connection has a yielding lock button (7), secured by a flexible tongue (8) to at least one of the end surfaces (11, 12) of the attachment (3), wherein said yielding lock button (7) is able to fit into a corresponding opening (15) of the wiper arm (5) and is able to snap in the wiper arm (5) when the attachment (3) of the wiper device is pressed into the wiper arm (5), characterized in that it has at least one locking wedge, configured to cooperate with the yielding lock button (7), on whose surface of the locking wedge (10) the yielding lock button (7) can move if it is tilted from the position of equilibrium, while the flexible tongue (8) is not tensioned. The invention also comprises a wiper blade (1) comprising such an attachment (3), secured to the wiper blade (1) by a connector (2), advantageously a rotational one. The invention also comprises an automotive wiper unit, comprising a wiper arm (5) and such a wiper blade (1).

The subject of the invention is an attachment for a windshield wiper, especially an automotive wiper, a wiper blade containing such an attachment, and an automotive wiper assembly having a wiper arm and such a blade.

There is a known design for fastening an automotive wiper blade to a wiper arm, in which the end of the wiper arm has an adapter with an opening, the blade is fastened by a connector to the attachment, which is provided with a locking button, secured to a flexible tongue, wherein the attachment and the adapter are configured to cooperate with each other so that the attachment can slide into the adapter, causing the lock button to enter the appropriate opening of the adapter and causing the button to snap (“click”) in this opening, bringing about a snap fastening of the connector in the adapter. In this same way, the wiper blade is snap fitted to the wiper arm. Since in the majority of cases it is desirable for the wiper blade to turn by a certain angle in the attachment, with respect to the axis of rotation essentially perpendicular to the length of the blade, the connection between the attachment and the connector is rotational and can be realized, for example, in that the attachment has a pair of coaxial openings on its opposite lateral surfaces, while the connector has a pair of coaxial pins cooperating with these openings, which pins after being placed in the openings secure the connector in the attachment and define an axis of rotation of the wiper blade relative to the attachment.

This type of fastening of a wiper blade to a wiper arm is described, for example, in international patent application No. WO 2013/030130 A1 and in European patent No. EP 1 403 156 B1.

An identified problem which occurs in this type of snap connection of the blade to the arm is the tendency of the connection to break due to the action of inertia which arises in the course of the working of the wipers (that is, when the wiper arm moves the blade attached to its tip over the windshield). This force is illustrated schematically in FIG. 1. The breaking of the connection may be the result, for example, of a partial damaging of this connection by the user during the mounting of the blade on the arm (when replacing wipers). The danger then exists of the blade falling off of the wiper arm while in motion. This is obviously a potentially unsafe and unwanted occurrence.

The defect of the snap-fit designs of the prior art, such as those described in publications WO 2013/030130 A1 and EP 1 403 156 B1, is the fact that the action of the aforementioned inertial force weakens the connection of the blade to the arm. Specifically, the design of the attachment and adapter is such that the commencing of an attempt to remove the blade from the arm weakens the mutual connection of these elements and increasingly less force is needed to continue this process. This means that these designs are rather susceptible to breaking.

The design disclosed in application WO 2013/030130 A1 comprises an attachment (presented in detail in FIGS. 4 and 5 in this application) which has a first element, designed to have the wiper blade pressed into it, and a second element, designed for a snap connection with the adapter of the wiper arm, while the first and second element are rotationally joined together. The second element has a pair of essentially parallel lateral surfaces and a top surface. All these three surfaces are configured and have dimensions such that the second element when pressed into the adapter of the wiper arm is fitted into this adapter and cooperates with it. Furthermore, on the upper surface of the second element there is a lock button, fastened by a flexible tongue to the one of the two upper side edges of the second element. The lock button, when the second element is pressed into the adapter of the wiper arm, fits into a corresponding opening of the adapter and snap-fits in it, creating a snap-fit connection of the blade and arm.

As mentioned above, this connection is susceptible to breaking.

Therefore, the problem of the present invention is to propose an improved snap connection of the wiper blade and arm, which minimizes the risk of breaking the connection.

Another problem of the invention is to improve the snap connection of the wiper blade and arm so that it is possible to control the point of fracture of the connection in the event that substantial forces are acting on the blade, and also to further minimize the risk of breaking of the connection.

According to the invention, the attachment of a wiper device, designed for fastening in a wiper arm by a snap-fit connection, designed and configured for its connection to a connector for fastening the wiper blade, wherein the said snap connection has a yielding lock button, secured by a flexible tongue to at least one of the end surfaces of the attachment, wherein said yielding lock button is able to snap in the wiper arm when the attachment of the wiper device is pressed into the wiper arm, is characterized in that it has at least one locking wedge configured to cooperate with the yielding lock button, on the surface of which locking wedge the yielding lock button can move if it is retracted from the position of equilibrium and the flexible tongue is not tensioned.

The end surface of the wiper attachment according to the present application is any external surface of the attachment, including in particular the right, the left, and/or the top side of the attachment.

Lack of tension in the flexible tongue (“the flexible tongue is not tensioned”), according to the present application, means that the tongue is not deformed in any plane or also—which is the equivalent—that the yielding lock button fastened to this tongue (or tongues) remains in the basic working position. Numerically speaking, the lack of tension of the flexible tongue in particular means that it may be under tension, but not greater than 5 MPa.

Advantageously, the attachment has an upper external surface, and the yielding lock button is situated on this upper external surface.

Advantageously, the attachment has at least a pair of end surfaces which are essentially parallel to each other, while said flexible tongue has an axis of rotation which runs essentially parallel to at least one of said end surfaces.

Advantageously, said locking wedge is situated at the rear of the yielding lock button, looking in the direction of the longitudinal axis of the wiper blade.

Advantageously, the attachment has two locking wedges, symmetrically situated at the rear of the yielding lock button, looking in the direction of the longitudinal axis of the wiper blade.

Advantageously, the attachment additionally has a locking wedge situated between the yielding lock button and one of the end surfaces of the attachment.

Advantageously, the attachment has at least one slot in the end surface of the attachment, between the flexible tongue and the side wall of the attachment.

Advantageously, the flexible tonge has a decreased width in the place of its connection to the end surface of the attachment as compared to the place of its connection to the yielding lock button.

Advantageously, the attachment is connected by said connector while ensuring at least one degree of freedom, advantageously transverse to the axis of rotation.

Advantageously, the attachment has a pair of coaxial openings, of round cross section, respectively situated in opposite end surfaces of the attachment that are essentially parallel to each other.

Advantageously, the attachment is a single part, advantageously made from at least one plastic material.

The invention also comprises a wiper blade which comprises such an attachment, secured to the wiper blade by a connector, advantageously a rotational one.

The invention also comprises an automotive wiper unit, comprising a wiper arm and such a wiper blade.

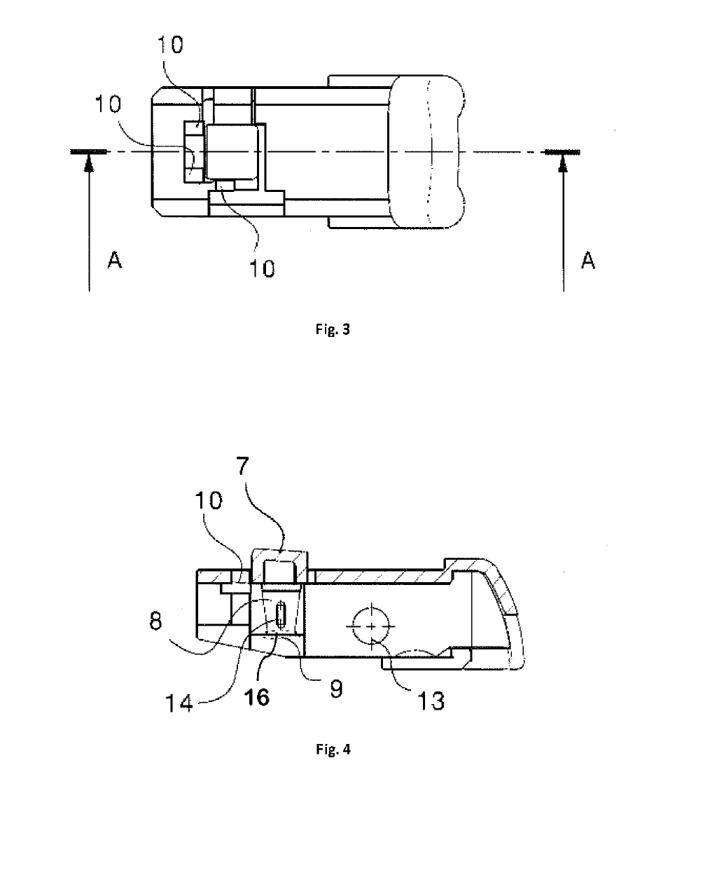

The terms used concerning the spatial orientation of the attachment according to the invention refer to a situation in which at one side of the attachment according to the invention is secured, via a connector, the wiper blade, and on the other side this attachment is forced into and secured by a snap-fit in an adapter, situated on the wiper arm. In regard to such a configuration of the attachment one can speak of a bottom and top surface of the attachment: the bottom surface is the surface which is turned toward the wiper blade. In turn, the top surface is the one turned toward the adapter. The lateral surfaces of the attachment are surfaces essentially perpendicular to the top and bottom surface and parallel to the direction along the wiper blade. The corresponding walls of the attachment are called the side walls. Finally, in such a spatial orientation one can speak of a “front” and “rear” of the attachment: the “front” is the side of the attachment located further from the axis of rotation of the wiper arm, while the “rear” is the side of the attachment which is closer to the axis of rotation of the wiper arm, looking in the direction along the wiper blade. For simplicity one can then say that the inertial force “pulling” the wiper blade from the attachment (FIG. 1) at the same time causes a displacement of the yielding lock button “to the rear” (FIG. 3). Such defined directions in space are obviously arbitrary, but they are used in the rest of the specification for convenience and clarity of the text.

The locking elements are situated and designed so that, as a result of the displacement of the yielding lock button in response to the occurrence of an inertial force (as shown in FIGS. 1 and 3), the bottom surface of the yielding button makes contact with the surface of the wedge and can move along it, according to the deformations experienced by the flexible tongue on which the yielding lock button is secured. Since the surface of the locking wedge rises as the distance increases from the yielding lock button, the larger the displacement of the yielding lock button due to the inertial force, the more the yielding lock button is pushed in the direction of the adapter situated at the end of the wiper arm and the more it is pressed in the corresponding opening of this adapter. This results in a strengthening of the connection between the wiper blade and arm, since the force needed to break this connection is increased.

In order to accomplish the described effect, at least one locking wedge is needed, situated (looking in the longitudinal direction of the wiper blade where it will be mounted in the attachment by a connector) on that side of the yielding lock button which is closer to the axis of rotation of the wiper arm after the mounting of the attachment in the adapter of that arm. For simplicity, one can speak of a position “at the rear of the yielding lock button”. In this case, the inertial movements of the blade in the longitudinal direction produce a supporting of the yielding lock bottom in this same direction thanks to the locking wedge. Optimally, the locking wedges working in this direction need to be placed behind the yielding lock button, symmetrically on either side of the attachment. It is best for the attachment to have two such wedges, arranged symmetrically with respect to the longitudinal axis of the wiper blade.

In an especially advantageous embodiment of the invention, the attachment furthermore has an additional locking wedge, placed with respect to the yielding lock button in a direction perpendicular to the one in which the locking wedges described in the previous paragraph are situated. For simplicity, one can speak of a position “at the side of the yielding lock button”. The so situated locking wedge works by an identical principle to that described above. In addition, it stabilizes and strengthens the connection between the wiper blade and arm in event of inertial movements of the blade in the transverse direction.

The yielding lock button is secured to the attachment by a flexible tonge. According to the invention, the tongue is connected to one of the side surfaces of the attachment, essentially below the upper edge of the attachment. Thanks to this, the yielding lock button has the ability—in a certain angle range—to turn relative to the axis of rotation lying in the side surface of the attachment and passing through the region of contact of the tongue with this side surface. Furthermore, the cross sectional area of the tongue is the smallest in the location where it contacts said side surface of the attachment. Thanks to this, it is possible to control any breaking of the connection in the event that the acting forces are very large—the tongue will break at its thinnest point. Since this point is located substantially below the yielding lock button, which is supported by the locking wedges, the risk of a total ejecting of the wiper blade from the adapter is limited thereafter, despite the breakage.

The slot deliberately left in the side surface of the attachment, beyond the flexible tongue, and in the direction of the locking wedges, facilitates the inertial displacement of the flexible tongue and also that of the yielding lock button in the longitudinal direction of the wiper blade, and therefore it facilitates the above-described cooperation between the yielding lock button and the locking wedges.

The invention will now be presented more closely in an advantageous sample embodiment in regard to the enclosed drawings, in which:

FIG. 1 illustrates the fastening of the wiper blade to the wiper arm by an attachment according to the invention and an adapter,

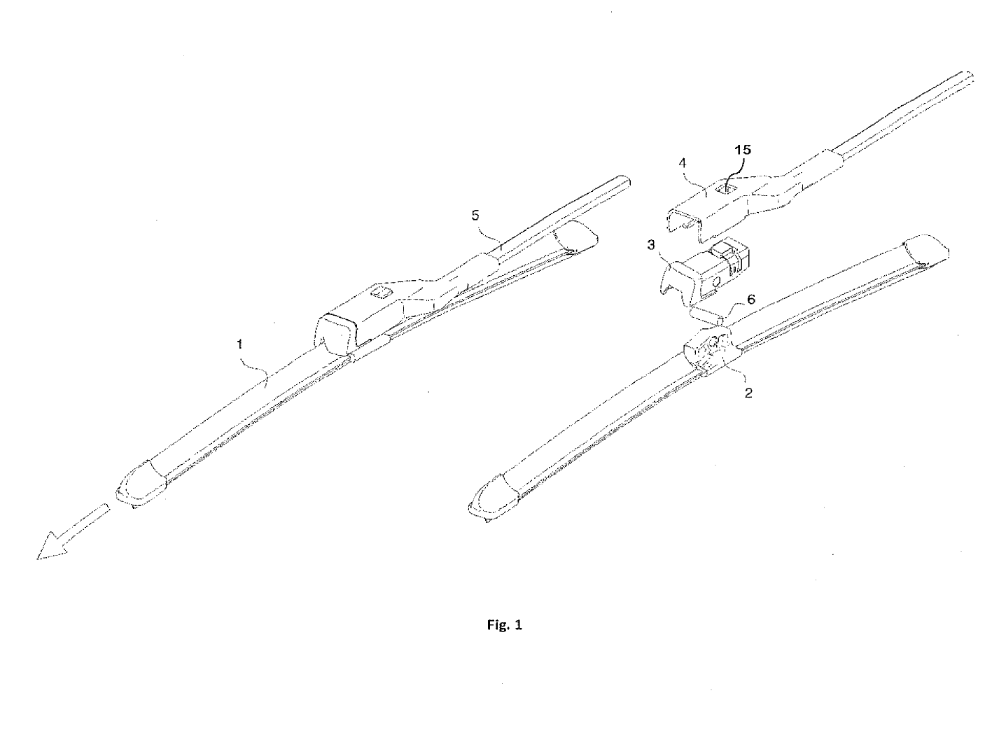

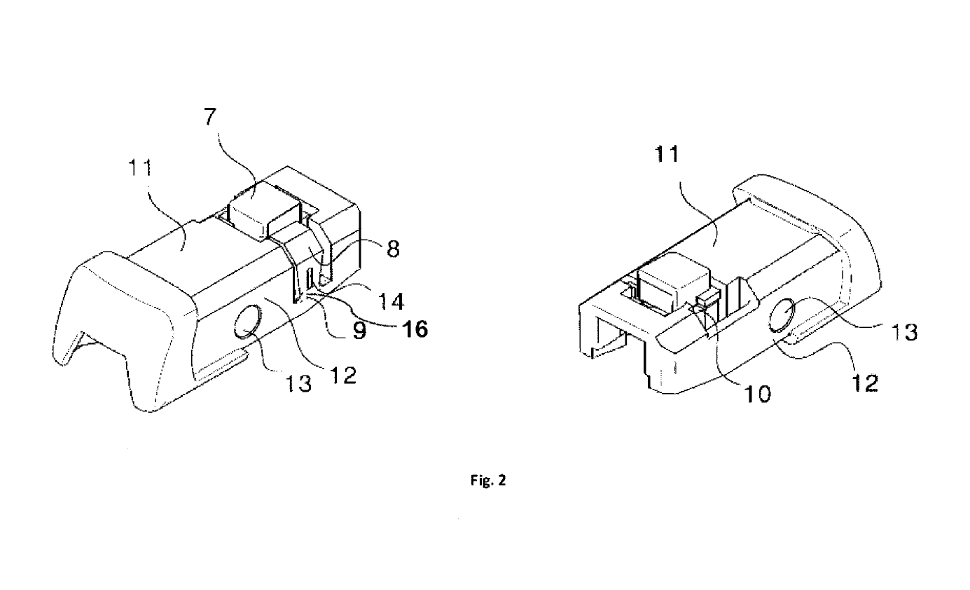

FIG. 2 shows the attachment according to the invention in an advantageous sample embodiment, in perspective view,

FIG. 3 shows the attachment of FIG. 2 in top view, while

FIG. 4 shows a cross section of the attachment of FIGS. 2 and 3 along line A-A.

The drawing uses the following designations: 1—blade, 2—connector, 3—attachment, 4—adapter, 5—wiper arm, 6—axis, 7—yielding lock button, 8—flexible tongue, 9—region of minimal cross sectional area of the flexible tongue, 10—wedging surface, 11—top surface of attachment, 12—side surface of attachment, 13—openings for securing the connector, 14—slot, 15—opening of wiper arm, 16—axis of rotation of the flexible tongue. FIG. 1 depicts by arrow the vector of the force pulling the blade 1 from the wiper arm 5 as a result of inertia. FIG. 3 depicts by arrow the vector of the corresponding force acting on the yielding lock button 7 of the attachment 3 according to the invention

### FAVOURABLE SAMPLE EMBODIMENT OF THE INVENTION

The enclosed drawings FIG. 2-4 show the attachment 3 according to the invention in a first advantageous sample embodiment. In the following text, the definitions regarding the spatial orientation of the attachment 3 according to the invention are used in keeping with the definition contained above in the text of the specification.

In the presented sample embodiment, the attachment 3 according to the invention has two essentially parallel side surfaces 12 and a top surface 11. These side surfaces 12 and top surface 11 are configured and dimensioned such that, when the attachment 3 is pressed into the adapter 4 of the wiper arm 5, it fits into this adapter 4 and cooperates with it. In particular, on the top surface 11 of the attachment is placed the yielding lock button 7, which when the attachment 3 is pressed into the adapter 4 of the wiper arm 5 is fitted into a corresponding opening of the adapter 4 and snaps in it, creating a snap-fit connection. The yielding lock button 7 is secured to one of the side surfaces 12 of the attachment by means of the flexible tongue 8. The place of connection of the flexible tongue 8 to the side surface 12 of the attachment is located essentially below the upper edge of the attachment. The cross sectional area 9 of the flexible tongue 8 is the smallest in the region where it contacts the side surface 12 of the attachment. Thanks to this fastening and minimization of the cross sectional area 9 of the tongue 8 in the location of its contact with the side surface 12 of the attachment, if the tongue 8 should break then this will occur precisely in the place of its contact with the side surface 12 of the attachment. And even in this case, given the fact that the yielding lock button 7 is supported by the locking wedges (described later on), a total ejecting of the wiper blade 1 is prevented. On both sides of the flexible tongue 8, in the side surface 12 of the attachment, there are slots 14 which facilitate the movements of the yielding lock button 7 in the direction along the wiper blade 1 that are caused by a force acting on the blade 1, such as the inertial force.

In the bottom part of the attachment are means of fastening the connector 2, designed for the seating of the wiper blade 1. In the sample embodiment presented, these means have the form of two round openings 13, situated coaxially on opposite side surfaces 12 of the attachment. The axes of rotational symmetry of these openings are congruent. The fastening and cooperation of the connector 2 and the attachment 3 to enable a rotational movement is realized by the axis 6 which is seated in the openings in the side walls 12 of the attachment and in a coaxial opening located in connector 2 (the axis 6 is a separate steel element). In an alternative embodiment, the connector 2 is provided with two round projections corresponding to the openings 13. The fastening of the connector 2 in the attachment 3 occurs by placing the round projections of the connector 2 in the round openings 13 of the attachment 3. In this way, a rotational connection of the connector 2 and the attachment 3 is produced, whereby said projections seated in the openings 13 become hinges, enabling (in a limited angular extent) a rotation of the connector 2 relative to the attachment 3. In each of these cases, the axis of rotation is the axis denoted by the congruent axes of rotational symmetry of the mentioned openings. This axis is essentially perpendicular to the longitudinal direction of the wiper blade 1.

In turn, to the rear of the yielding lock button 7 are two locking wedges 10, situated at the ends of the yielding lock button 7, on either side of it, symmetrical with respect to the longitudinal direction of the wiper blade 1. In addition, at the side of the button 7, on the side opposite that where the flexible tongue 8 is located, the attachment 3 has an additional locking wedge. The surfaces of all the locking wedges 10 rise as the distance increases from the yielding lock button 7. Accordingly, all of the locking wedges 10 operate in a way so that, if the yielding lock button 7 moves away from the position of equilibrium—to the direction of the rear, looking along the wiper blade 1, or to the side (i.e., in the direction of one of the side surfaces 12 of the attachment)—they support the yielding lock button 7 and push it upward, at the same time forcing it into the appropriate opening of the adapter 4. Thanks to this, the force needed to pull the attachment 3 from the adapter 4 is increased—thus strengthening the connection of these two elements.

As for the material used to make the attachments 3 according to the invention, these are typically elements moulded from plastic, especially such plastics as polyoxymethylene (POM) or polybutylene terephthalate (PBT), which are commercially available under the names Hostaform and Ultradur, respectively. Alternatively, one can use other materials familiar to the person skilled in the art.

In one of the proposed variant embodiments of the invention, it is proposed to make the attachment 3 as a single moulded element.

The attachments 3 according to the invention ensure a stable connection between the wiper blade 1 and its arm 5, and thanks to the appropriate configuration and arrangement of the locking surfaces and their interaction with the yielding lock button 7 they minimize the risk of the blade 1 being ejected if this connection is broken.

1. An attachment of a wiper device for fastening in a wiper arm by a snap-fit connection, the attachment being connected to a connector for fastening the wiper blade,
wherein said snap-fit connection has a yielding lock button, secured by a flexible tongue to at least one of end surfaces of the attachment,
wherein said yielding lock button is able to fit into a corresponding opening of the wiper arm and is able to snap in the wiper arm when the attachment of the wiper device is pressed into the wiper arm
the attachment comprising at least one locking wedge, configured to cooperate with the yielding lock button, wherein the yielding lock button moves on a surface of the at least one locking wedge when the locking wedge is tilted from the position of equilibrium, while the flexible tongue is not tensioned.

2. The attachment according to claim 1, further comprising it has an upper external surface, wherein the yielding lock button is situated on the upper external surface.

3. The attachment according to claim 1, comprising at least a pair of end surfaces, parallel with each other, while said flexible tongue has an axis of rotation that is parallel to at least one of said end surfaces.

4. The attachment according to claim 1, wherein said locking wedge is located at the rear of the yielding lock button, facing in a direction of the longitudinal axis of the wiper blade.

5. The attachment according to claim 1, further comprising two locking wedges, symmetrically situated at the rear of the yielding lock button, facing in the direction of the longitudinal axis of the wiper blade.

6. The attachment according to claim 1, further comprising a locking wedge placed between the yielding lock button and one of the end surfaces of the attachment.

7. The attachment according to claim 1, further comprising at least one slot one of the end surfaces of the attachment, between the flexible tongue and the side wall of the attachment.

8. The attachment according to claim 1, wherein the flexible tongue has a decreased width in the place of its connection to the end surface of the attachment as compared to the place of its connection to the yielding lock button.

9. The attachment according to claim 1, wherein the attachment is connected to said connector while assuring at least one degree of freedom by an axis of rotation.

10. The attachment according to claim 1, further comprising a pair of coaxial openings, of round cross section, respectively situated in opposite end surfaces of the attachment and parallel to each other.

11. The attachment according to claim 1, wherein the attachment is single part made from at least one plastic material.

12. A wiper blade comprising an attachment according to claim 1, secured to the wiper blade by a rotational connector.

13. An automotive wiper unit, comprising a wiper arm and a wiper blade according to claim 12.
